(19) United States
(12) Patent Application Publication
(10) Pub. No.: US 2025/0261036 A1
(43) Pub. Date: Aug. 14, 2025

(54) METHODS FOR WIRELESS COMMUNICATION OF A DATA SET OF INTER-DEPENDENT DATA

(71) Applicant: Sony Group Corporation, Tokyo (JP)

(72) Inventors: Torgny PALENIUS, Barsebäck (SE); Basuki PRIYANTO, Lund (SE); Anders BERGGREN, Lund (SE); Svante ALNÅS, Lund (SE)

(21) Appl. No.: 18/858,688

(22) PCT Filed: Mar. 27, 2023
(86) PCT No.: PCT/EP2023/057789

§ 371 Date: Oct. 21, 2024

(30) Foreign Application Priority Data
May 6, 2022 (SE) 2250555-6

(51) Int. Cl. H04W 28/02; H04L 1/00; H04W 72/0446; H04W 72/1263

(52) U.S. Cl. CPC H04W 28/0268; H04L 1/0003; H04W 72/0446; H04W 72/1263

(57) ABSTRACT

A method carried out in an access node of a wireless network for configuring communication of data with a user equipment, UE, the method comprising: obtaining (400) a quality of service, QoS, indicator associated with a data set comprising inter-dependent data, wherein said obtained QoS indicator identifies an increasing reliability level over the data set in time domain; scheduling (430) resources for communication of the data set with the UE according to said obtained QoS indicator.

### TECHNICAL FIELD

This disclosure is related to wireless communication between a wireless device and a wireless network. Specifically, solutions are provided for configuring devices of the wireless network to facilitate successful communication of a data set comprising inter-dependent data.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

In the legacy 5G system, traffic with known periodicity and packet size, e.g. voice, is supported using SPS PDSCH (Semi-Persistent Scheduling, Physical Downlink Shared Channel) and CG PUSCH (Configured Grant, Physical Uplink Shared Channel). These types of scheduling of data communication have evolved throughout different releases (Rel) of the 3GPP specifications. In this context, repetitive scheduling may be configured with a period of a certain number of subframes or slots.

While wireless network specifications were originally developed to support voice traffic, communication of data between the UE and the wireless network is nowadays the dominating use case. 5G NR (New Radio) was introduced to support different types of service categories, including eMBB (Enhanced Mobile Broadband) for high data rates, URLLC (Ultra Reliable Low Latency Communications) for low latency and/or high reliability, and mMTC (Massive Machine-Type Communications) for a high number of low-complexity devices. As capacity increases, new types of data transfer and new purposes for data communication continue to emerge. For example, Extended Reality (XR) refer to various types of augmented, virtual, and mixed environments, where human-to-machine and human-to-human communications are performed with the assistance of handheld and wearable end user devices (UEs). XR covers several applications, such as Virtual Reality (VR), Augmented Reality (AR), and Cloud Gaming (CG), in which the main characteristics are requiring relatively high data rate and low latency. Hence, 5G NR was not designed to support the combination of the aforementioned requirements which are suitable for XR applications. In other words, XR may not be optimally operated in a 5G NR network, such as unable to reaching the required data rate/latency. Operating an XR application using legacy service categories may also result in high UE energy consumption, thus reducing user experience (e.g., short battery life) and transmission of data in vain since other related parts can be missing. XR applications, however, has a unique characteristic that their traffic pattern is deterministic (i.e., certain periodicity and certain number of traffic flows). There are also some other applications with multiple data streams requiring different characteristics would also be relevant, like factory automation, remote machine operation, UAV operation, or just to differentiate between video and audio.

For various applications, such as XR and media services, certain data may comprise groups or chunks of data which is inter-dependent. This is referred herein as a data set. In some examples of 3GPP terminology, such a data set may be referred to as a PDU (Protocol Data Unit) Set, which as such comprises a group of packets used to carry inter-dependent payload, such as e.g. a frame, video slice/tile, audio samples, haptics application data or remote control data. In another example, a date set may be referred to as a subset of a PDU Set. In media layer, packets in such a PDU Set are decoded/handled as a whole. For example, the frame/video slice may only be decoded in case all of the packets carrying the frame/video slice are successfully delivered. A frame within a GOP (Group of Pictures) can only be decoded by the client in case all frames on which that frame depends are successfully received. Hence the groups of packets within the data set, e.g. PDU Set, have inherent dependency on each other in media layer. Without considering such dependencies between the packets, 5GS may perform a scheduling with low efficiency. For example, the 5GS may randomly drop a packet but try to deliver other packets of the same frame/video slice which are useless to the client and thus waste of radio resources.

In some aspects, a data set of inter-dependent data is thus characterized in that all data of the data set must be successfully delivered, e.g., from an access node to a UE, for a data object, such as a video frame, represented by the data set to be decoded properly.

### SUMMARY

An overall objective of the proposed method is to provide solutions for configuring communication of a data set comprising inter-dependent data. An aspect of this objective is to provide solutions that facilitate successful transfer of all data of a common data set, to counteract latency problems or allocation overhead caused by retransmission. The proposed solution is defined by the terms of the independent claims, while further advantageous embodiments are set out in the dependent claims and in the detailed description.

According to a first aspect, a method that is carried out in an access node of a wireless network, for configuring communication of data with a UE is provided. The method comprises:
obtaining a quality of service, QoS, indicator associated with a data set comprising inter-dependent data, wherein said obtained QoS indicator identifies an increasing reliability level over the data set in time domain;
scheduling resources for communication of the data set with the UE according to said obtained QoS indicator.

An access node of the wireless network comprises:
a transceiver for wireless communication with a user equipment; and
logic circuitry configured to control the access node to carry out the proposed method.

According to a second aspect, a method carried out in a core network of a wireless network is provided, for configuring an access node to handle communication of a data set comprising inter-dependent data, the method comprising:
configuring the access node with a quality of service, QoS, identified by a QoS indicator, wherein said QoS identifies an increasing reliability level over the data set in time domain, to be targeted by the access node for communication of the data set.

Based on the proposed solution, a mechanism is obtained which allows for resource scheduling with increasing reliability during ongoing communication of a data set of inter-dependent data. Specifically, a solution is provided which increases the chances for successful communication of the complete data set, once communication has begun. This is particularly useful when the data of the data set is useless unless the full set of data is conveyed, such as for frames of data.

### BRIEF DESCRIPTION THE DRAWINGS

FIG. 1 schematically illustrates an implementation of a wireless communication system, in which a UE communicates with an access node of a wireless network by radio communication. Various entities of a core network of the wireless network are further shown.

FIG. 2 schematically illustrates a UE configured to operate with the wireless network according to various examples.

FIG. 3 schematically illustrates an access node configured to operate in the wireless network for communication with the UE according to various examples.

FIG. 4A is a flowchart of a method for operating an access node according to various embodiments of the proposed solution.

FIG. 4B shows a method carried out in a core network for configuring an access node according to the proposed solution.

FIG. 5 shows a diagram illustrating how a set of data related to a video frame of an XR application is conveyed in downlink through various entities of the wireless system.

FIG. 6 illustrates an architecture with different network functions involved in sending data to the UE, and usable for configuring data set communication according to various embodiments.

FIG. 7 is a signaling diagram, which illustrates various parts of different embodiments of the proposed solution.

FIG. 8 schematically illustrates a varying control parameter for configuring an increasing reliability level during communication of a data set, according to an embodiment.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

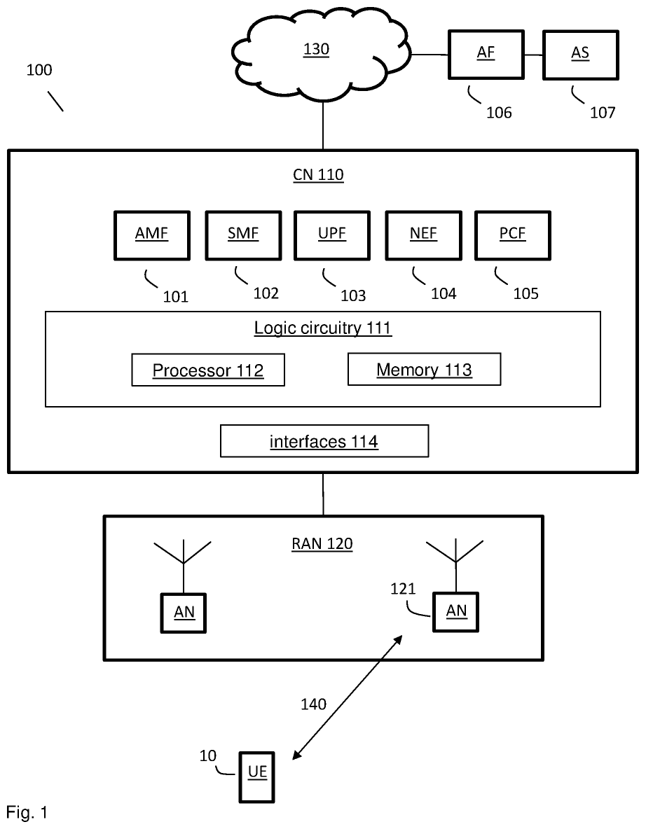

FIG. 1 illustrates a high-level perspective of operation of a UE 10 in a wireless system, configured to communicate with a wireless communication network 100, denoted wireless network 100 for short herein. FIG. 1 is useful for context of the proposed solution, and illustrates various entities and functions which cooperate in wireless system.

The wireless network 100 may be a radio communication network 100, configured to operate under the provisions of 5G as specified by 3GPP, according to various examples, or further generations. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the Access and Mobility Management Function (AMF) 101, a Session Management Function (SMF) 102, a User Plane Function (UPF) 103, a Network Exposure Function (NEF) 104, a Policy Control Function (PCF) 105, all of which are legacy functions of the 5G system. One or more Application Functions (AF) 106 may be deployed outside of the 5G system i.e. as an application running on an application server (AS) 107 connected to the external network e.g. the Internet, which application server provides data for communication in the wireless system. Operators may deploy the AF 106 as trusted or non-trusted. A trusted AF 106 may have access to all interface with the CN 110 while an un-trusted must access anything inside the CN via the NEF 104.

The CN 110 comprises logic circuitry 111 configured to render and control various CN functions and entities, such as the described CN functions 101-105. The logic circuitry 111 may include one or more processing device(s) 112, including one or multiple processors, microprocessors, data processors, co-processors, and/or some other type of component that interprets and/or executes instructions and/or data. Processing device 112 may be implemented as hardware (e.g., a microprocessor, etc.) or a combination of hardware and software (e.g., a system-on-chip (SoC), an application-specific integrated circuit (ASIC), etc.). The processing device 112 may be configured to perform one or multiple operations based on an operating system and/or various applications or programs. The logic circuitry 111 may further include memory storage 113, which may include one or multiple memories and/or one or multiple other types of storage mediums. For example, memory storage 113 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.). The memory storage 113 is configured for holding computer program code, which may be executed by the processing device 112, wherein the logic 111 is configured to generate and operate various CN functions, including legacy 5G CN functions, and further to define QoS settings, requirements, and parameters according to the proposed solution as provided herein for use in scheduling and communication between the wireless network 100 and the UE 10. It will be understood that the various functions of the CN 110 may be realized by a number of different nodes, each being provided with its own logic circuitry.

The CN 110 further comprises interfaces 114, which provide communicative connection in multiple layers with one or more access networks 120 and external entities such as other networks 130.

The CN 110 is connected to at least one access network 120, also referred to as a Radio Access Network (RAN), comprising one or more base stations or access nodes, of which one access nodes 121 is identified in the drawing. The access node 121 is a radio node configured for wireless communication on a physical channel 140 with various UEs. The physical channel 140 may be used for setting up one or more logical channels between UEs and the wireless network.

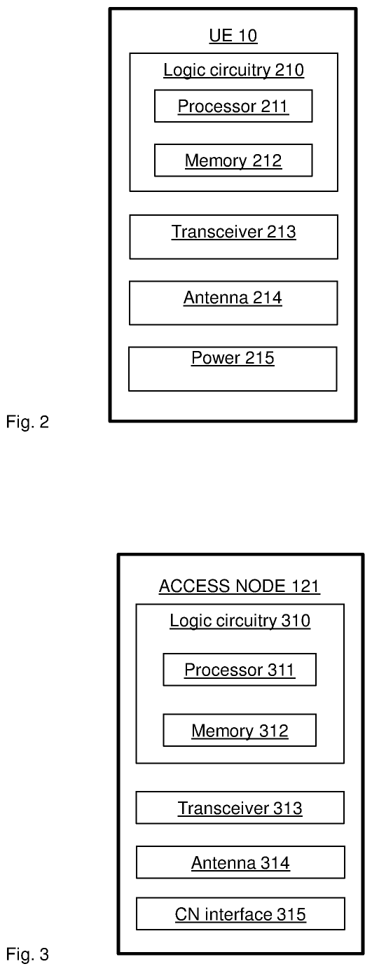

FIG. 2 schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 (e.g., a battery) that provides energy to the other components of the UE 10.

FIG. 3 schematically illustrates a radio node in the form of an access node 121 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on the physical channel 140. The logic circuitry 310 may realize a scheduler for scheduling communication of a data set according to the solutions proposed herein, and for configuring the UE to operate according to the scheduling, based on a related QoS.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an isotropic sensitivity profile of the antenna array to transmit radio signals in a particular transmit direction. The access node 121 may further comprise an interface 315, configured for communication with the core network 110. Obviously, the access node 121 may include other features and elements than those shown in the drawing or described herein, such as a power supply and a casing etc.

In current 5GS, the QoS Flow is the finest granularity of QoS differentiation in a PDU Session. The 5G QoS characteristics is determined by the 5QI, 5QI (5G QoS Identifier). The 5QI is a pointer to a set of QoS characteristics such as priority level, packet delay or packet error rate, etc. This implies that each packet in a QoS flow is treated according to the same QoS requirements. In order to further clarify problems associated with legacy QoS Flow comprising constant QoS requirements, reference can be made to video coding. In video coding, a group of pictures (GOP) is commonly used. The GOP is a collection of successive pictures within a coded video stream. A GOP can contain the following picture types:
I frame (intra coded picture, also called keyframe)—a picture that is coded independently of all other pictures. Each GOP begins (in decoding order) with this type of picture.
P frame (predictive coded picture)—contains motion-compensated difference information relative to previously decoded pictures. In older designs such as H.262/MPEG-2 and each P frame can only reference one picture, and that picture must precede the P frame in display order as well as in decoding order and must be an I or P frame. These constraints do not apply in newer standards and HEVC (High Efficiency Video Coding).
B frame (bi-predictive coded picture)—contains motion-compensated difference information relative to previously decoded pictures. In older designs such as MPEG-1 and H.262/MPEG-2, each B picture can only reference two pictures, the one which precedes the B picture in display order and the one which follows, and all referenced pictures must be I or P pictures. These constraints do not apply in newer standards H.264/MPEG-4 AVC and HEVC.
D frame (DC, direct coded picture)—serves as a fast-access representation of a picture for loss robustness or fast-forward. D frames are only used in MPEG-1 video.

An I frame indicates the beginning of a GOP. Afterwards several P and B frames follow. XR transmission typically involves video transmission. A video transmission, particularly a video transmission with high quality, may require large packet size. A large packet size is typically divided into sub-packets or PDUs, belonging to a PDU set. Each sub-packet is transmitted in a wireless channel 140 from the access node 121 to the UE 10, or vice versa. It may occur that one or more sub-packet are not received at the receiver side, for example, due to a bad wireless channel condition. For video transmissions, usually a frame needs to be delivered in time or the whole frame will be discarded since there is no time for retransmissions. So, to make sure all sub-packets belonging to the same data set, e.g. video frame, can be delivered, and to avoid potential retransmission, and to utilize radio resources efficiently, an improved mechanism is needed.

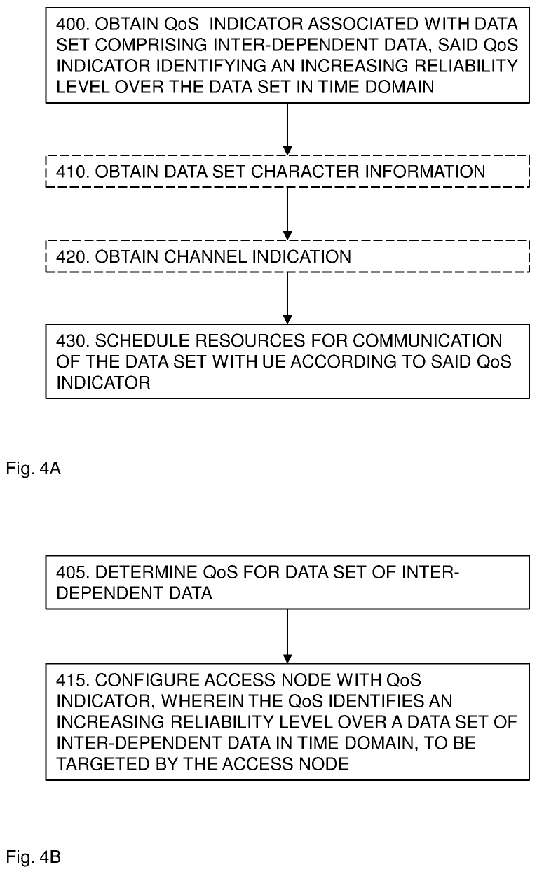

FIG. 4A shows a flowchart of a general presentation of a method carried out in the access node 121 of the wireless network 100, for configuring communication of data with the UE 10, wherein method steps provided in boxes with full line contours identify a general aspect of the proposed solution. According to related aspect, the access node 121 comprises a transceiver 313 for wireless communication with the UE 10, and logic circuitry 310 configured to control the access node to carry out the method of FIG. 4 and as further provided herein.

In step 400 the access node 121 obtains a QoS indicator associated with a data set comprising inter-dependent data, wherein said obtained QoS indicator identifies an increasing reliability level over the data set in time domain. In other words, the QoS indicator configures communication of the data set such that a second part of the data set is communicated with higher reliability than a first part, wherein the second part is communicated after the first part. The QoS indicator may come along with the associated parameters, such as a pattern or scheme for reliability increase. Such parameters may define how, when, and to what extent reliability shall be increased be carried out through communication of the data set. In an alternative embodiment, the parameters are specified and predetermined, e.g. as QoS parameters listed in a technical specification, wherein the QoS indicator merely refers to the specified parameters. The QoS indicator may be obtained from the CN 110. The QoS indicator may be requested by the AF 106 and conveyed to the access node 121 by CN 100 according to legacy behavior. In addition, the UPF may also convey QoS indicators to access node 121. The configuration may be accomplished in various ways as described in detail by examples below.

In step 410, optionally included in various embodiments, the access node 121 may obtain data set character information, associated with data set. Specifically, the increase of reliability level as identified by the QoS indicator may be dependent on the data set character information. The data set character information may identify progress in communication of the data set. The data set character information may be obtained in the access node from the data set as such, such as header information in data units of the data set, e.g. GTP-U (GPRS Tunnelling Protocol-U) headers, and may e.g. comprise one or more of size information, sequence number, total number of data units. As another alternative, the data set character information may be obtained from the CN 110 as separate information associated with a QoS Flow set up for the data set, e.g. from the AMF 101. In yet another alternative, the access node 121 may autonomously determine the data set character, e.g. based on input from the CN 110 and/or based on a predetermined rule for configuring the data set. More detail related to examples of the data set character information are given further below, which may be combined in any way. It may be noted that the obtainment 410 of the data set character information may be carried out repetitively in conjunction with ongoing scheduling 430, e.g. by progressively obtaining header information which controls the scheduling to obtain the increasing reliability.

In step 420, optionally included in some embodiments, the access node 121 obtains a channel indication, indicating a quality of the channel for communicating the data between the access node 121 and the UE 10. The channel indication may be used for scheduling of resources. The channel indication may be determined based on channel measurements. For downlink (DL) communication, the channel indication may be obtained from the UE 10, where the measurement is carried out, whereas for UL communication, the access node 121 may determine the channel indication. This is as such known from 3GPP legacy behavior, and will therefore not be discussed in detail. Nevertheless, it may be noted that the reliability in the legacy downlink transmission in NR is measured based on channel quality measurement and report by the UE. In 3GPP technical specification TS 38.214 V17.0.0, it is described how the UE determines channel quality index (CQI) associated with the corresponding modulation order and coding rate of DL (clause 5.2) resp UL (clause 6.1.4). In DL the UE typically reports with the CSI report what combination of modulation order and code rate is feasible to achieve a target Block Error Rate (BLER), such as 10% or even lower for URLLC. The access node (gNB) subsequently uses the CSI report to estimate what parameters it shall use to obtain the target BLER. According to various embodiments of the proposed solution, the same functionality may be used to change the reliability during the transmission of the data set, i.e. for increasing a target reliability level during ongoing communication of a data set, such as a PDU Set. This may involve scheduling resources based on a decreasing target BLER. It may be noted that the obtainment 420 of a channel indication may be carried out repetitively in conjunction with ongoing scheduling 430, as changing channel conditions may affect the scheduling to obtain the increasing reliability.

In step 430 the access node 121 schedules resources for communication of the data set with the UE according to said obtained QoS indicator. This may involve executing the QoS indicator. In other words, the access node 121 schedules resources for communication of the data set with the UE according to said QoS, such that an increase in reliability in time domain between at least two successive data units of said data set is obtained, such that the last data unit is transmitted with higher reliability than the first data unit, of a common data set. By means of the proposed solution, a mechanism is thus provided wherein an increasing reliability level is applied, so as to ensure that if the initial data units are delivered successfully, the remaining data units are delivered with increased priority. A technical effect is thus increased likelihood that a complete set of inter-dependent data is successfully communicated, i.e. transmitted or received, once the communication has been initiated. In other words, the risk that that the initial packets of the data set are transmitted in vain is decreased. As a result, improved usage of resources is obtained.

According to related aspect, illustrated in FIG. 4B, the proposed solution comprises a method carried out in the CN 110 of the wireless network 100 for configuring the access node 121 to handle communication of a data set comprising inter-dependent data.

In step 405, this method may comprise determining 405 a QoS, for use in a flow for communicating the data set, such as QoS Flow. The determination of the QoS may be carried out by negotiation with the AF 106.

In step 415, the CN 100 configures the access node with a QoS indicator, identifying the QoS.

The QoS identifies an increasing reliability level over the data set in time domain, to be targeted by the access node for communication of the data set.

The configuration may contain an initial or average reliability level of a data set, and/or the pattern of increasing reliability level over the data set.

Examples and various detailed embodiments of the proposed solution will be described going forward.

It will be understood that reliability, in the context of data communication and the proposed solution, indicates a measure or setting identifying a likelihood of successful communication of the data, for instance that the communication is configured such that data is successfully received and decoded. Successful communication may in this respect be related to a certain acceptable error rate. A level of reliability, as identified by the QoS indicator, may be explicit, implicit, or relative, in various examples of the proposed solution. The QoS according to the proposed solution, usable for a QoS Flow for transmission of a data set of inter-dependent data, may be identified by the QoS indicator, such as one or more new 5Qis, pointing to QoS characteristics to use for the data communication. Specifically, the QoS indicator identifies increasing a reliability level to be met in time domain for communication of a data set.

The QoS indicator according to the proposed solution may control the scheduling such that resources are configured to obtain an increase in reliability between at least two successive data units of said data set. In a data set obtained from the AF 106 and configured as a PDU Set, the data units may be PDUs. In the access node 121, scheduling may be controlled to apply the reliability level increase, based on the QoS indicator and the received PDU Set, between two data units in the form of configured transport blocks for communication of the data set.

Referring back to the obtainment 410 of data set character information, various examples are given below, which may be combined in any way.

According to a first one example, the data set character information comprises an indication of a total amount of data in the data set comprises an indication of a total amount of data in the data set. This may be defined as a measure of magnitude of the data, e.g. in bytes, and/or a number of data units comprised in the data set. According to a variant of this example, the indicated total amount is a predetermined size of the data set, such as an indication of maximum size.

According to a second example, the data set character information may comprise a sequence numbering of data units in the data set. In one embodiment, sequence numbering is identified together with each data unit of the data set, e.g. in header information, such as in each GTP-U header of each PDUs. In a variant of this embodiment, only some data units of the data set are provided with a sequence number. In yet another embodiment, the access node 121 determines the sequence numbering, either by counting of data units through the data set, or determined based on data units (e.g. transport blocks) configured by the access node 121 to contain the data of the data set.

The QoS indicator may identify an increase in reliability level to be met during progress of communication of the data set. According to some examples, the QoS indicator identifies a relative time within the data set for increasing the reliability level. This may be based on the data set character information of the first and/or the second example provided above. The QoS indicator may e.g. indicate that an increase in reliability level shall be configured dependent on a certain fraction or percentage of the total amount of data of the data set having been sent, or remaining to be sent. In an alternative embodiment, the QoS indicator may indicate that an increase in reliability level shall be configured at a certain time after scheduled commencement of the data communication, or with a certain interval expressed in data size or number of data units.

According to another example, the data set character information may comprise an indication to increase the reliability rate after an identified data unit of said data set, which is obtained from the CN 110. The QoS indicator may thus indicate to the access node to increase the reliability level responsive to receiving such indication to increase. The indication to increase may be provided in one or more data units, such as in header information, and may be configured by the CN 110 or the AF 106.

According to a version of this example, the access node 121 may obtain an indication of priority for respective data units of the data set. Such indication of priority may be provided in some or all data units, such as in the GTP-U Header of the PDUs of a PDU Set. The QoS indicator may identify that an increase of reliability shall occur dependent on such priority. Specifically, in order to meet the objective of the proposed solution, the indication of priority configured in the data set is configured such that the scheduling provides one of either increased or maintained reliability in time domain between successive data units of the data set, based on said priority. The concept of comprising an indication of priority for the data units of the data set, which as such may be used for other purposes, is thus here used to increase the likelihood of successful communication of a complete data set.

According to some examples, the QoS indicator identifies that the level of reliability shall be gradually improved/increased through a data set, which may be accomplished by increased usage of radio resources used for transmitting the data set, e.g. a frame.

Various embodiments are described below, based on the one or more of the examples provided above.

According to one example, the QoS indicator identifies QoS characteristics for a single reliability level, and a rule or scheme for configuring the reliability level to increase through the data set dependent on the identified reliability level. In this context, the single identified reliability level may be an initial reliability level to meet for a first data unit of the data set, or a final (highest) reliability level to meet for a last data unit of the data set, or an average reliability level for the data set. Regardless of the importance level of the data set, this allows the access node 121 to use adaptive QoS treatment within the data set, e.g. within a PDU Set. In one example, the QoS indicator identifies that a first part of the data set shall be communicated with a first, initial, reliability level. The first part may be a relative part of the data set, such as a first percentage or fraction of the amount of data in the data set or of the total number of data units in the data set. This may e.g. identify that the first 25% of the data packets in the data set shall be communicated in accordance with the first reliability level. This may be obtained by scheduling a first, relatively low, level of radio resources and/or a relatively low complexity coding and modulation scheme. The QoS indicator may further identify that a last part of the data set shall be communicated with a second, final, reliability level, such as a second percentage or fraction of the amount of data in the data set or of the total number of data units in the data set. This may e.g. identify that the last 25% of the data packets in the data set shall be communicated in accordance with the final reliability level. This may be obtained by scheduling a second, relatively high, level of radio resources and/or a relatively high complexity coding and modulation scheme. Data packets between the first part and the second part may be transmitted in accordance with a third reliability level, e.g. in accordance with an intermediate level of reliability level, such as an identified average reliability level. In other variants of this example, the QoS indicator may identify only one increase (i.e. only two reliability levels) to be met through the data set, or more than three reliability levels.

The proposed solution can be applied for any type of data set, such as a PDU Set. The data set may e.g. represent one of an I-, P-, B-, or D-frame. In this context, it may be noted that the data set, within which an increasing reliability is indicated by the QoS indicator, may be a sub-portion of a PDU Set. The PDU Set may for instance thus comprise data for more than one frame, where the data representing one frame forms the inter-dependent data of one data set. A PDU Set may e.g. contain data for one I-frame and one P-frame, by way of example, each representing one data set which may be treated with different reliability levels according to the QoS indicator. Data packets for the different data sets may further be mixed in order in time domain. For example, the PDU Set could start with first data packets for the I frame to be communicated with e.g. a reliability level 5, then P-frame data to be communicated with reliability level 3, subsequently P-frame data packets with a reliability level 4, I frame data packets with a reliability level 6, etc.

Where the QoS indicator identifies an increase in reliability level at a relative position or point in time in progression of the data set, such as a percentage level, the access node 121 needs to be aware of the progress. As described above, this may be determined based on the obtained 420 data set character information, including the total amount of data in the data set.

The proposed solution is applicable where the time to transfer the data set, e.g. one PDU Set, takes longer time than e.g. 1 ms and is not transmitted in one TB (Transport Block). I.e. the data set is transferred during a time period.

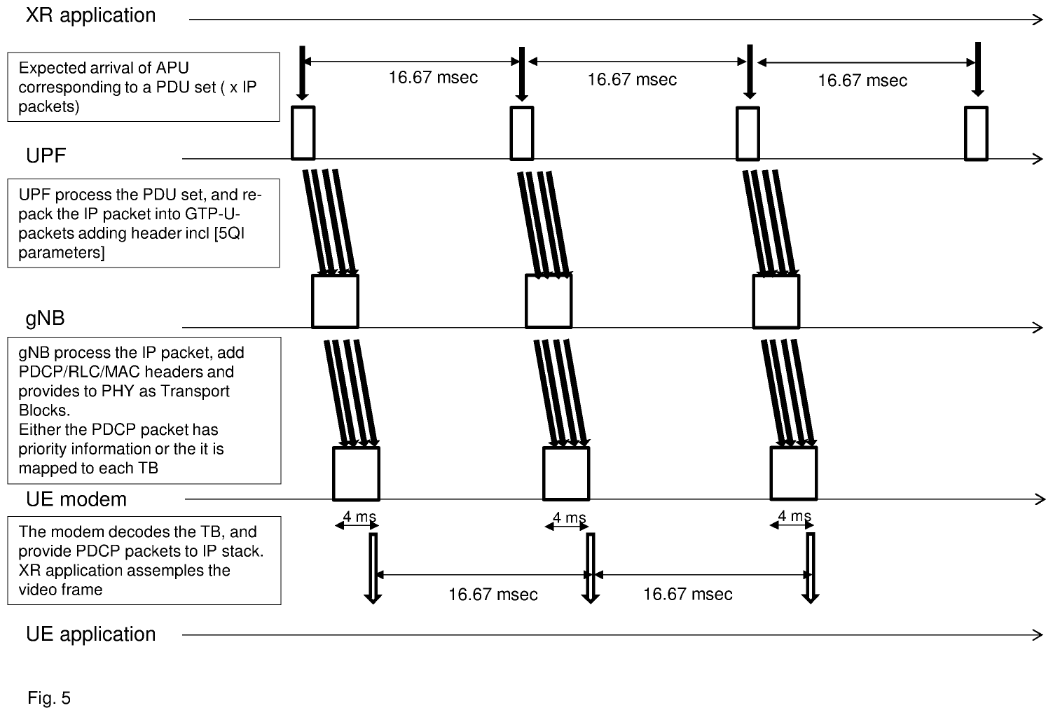

An illustrative example of the proposed solution may be given with respect to a communication of a data set comprising data for a video frame, which is schematically illustrated in FIG. 5. Since the delivery of a video frame, e.g. transmitted at a rate of 60 FPS, (i.e, corresponding to a periodicity of 16.7 ms), the duration of the transfer needs to be shorter than 16.7 ms, but preferably even shorter to handle potential retransmission and to support required latency requirements. In the shown example, it is assumed that a transfer time for the entire data set is 4 ms over air interface, and that the PDU Set cannot be delivered within in one TB, a number of TB needs to be transmitted. Based on the proposed solution, the TBs should be transmitted with different reliability, where the reliability level increases from the first to the last transmission within a PDU Set. QoS characteristics, identified by the QoS indicator, may thus identify a PDU Set Error Rate (PSER), e.g. an upper bound for the ratio between the number of PDU Sets not successfully received and the total number of PDU Sets sent towards a recipient measured over a measurement window. The PSER can be used by the communication system to set rate adaptation target, number of HARQ retransmission, RLC parameters based on PSER. Specifically, the QoS indicator may identify a decreasing PSER over the data set, according to the solution proposed herein. Mapping of the QoS indicator to the associated QoS characteristics may be provided by a standardized table.

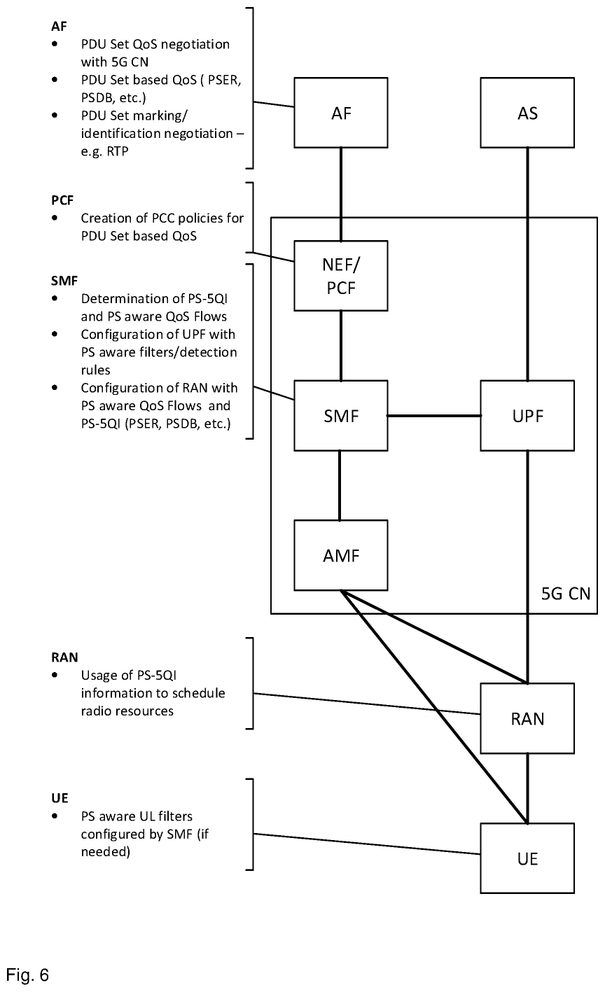

FIG. 6 schematically illustrates PDU Set based QoS framework, with entities indicated which have been described with reference to FIG. 1, and which are legacy to 5G. This is a proposed framework, which indicates that QoS for communication of a data set, in the form of a PDU Set, is negotiated between the CN 110 and the AF 106. A CN function, such as the SMF 102 determines a QoS indicator for a QoS Flow for conveying the data set, and configures the UPF 103 with filters and detection rules and the RAN 120, such as the access node 121. Data subsequently conveyed over the user plane, e.g. from the AS 107 via the UPF 103 to the access node 121, is then scheduled by the access node 121 based on the QoS indicator from the CN and the UPF. Specifically, the QoS indicator controls scheduling such that the reliability level is increased in time domain along the data set.

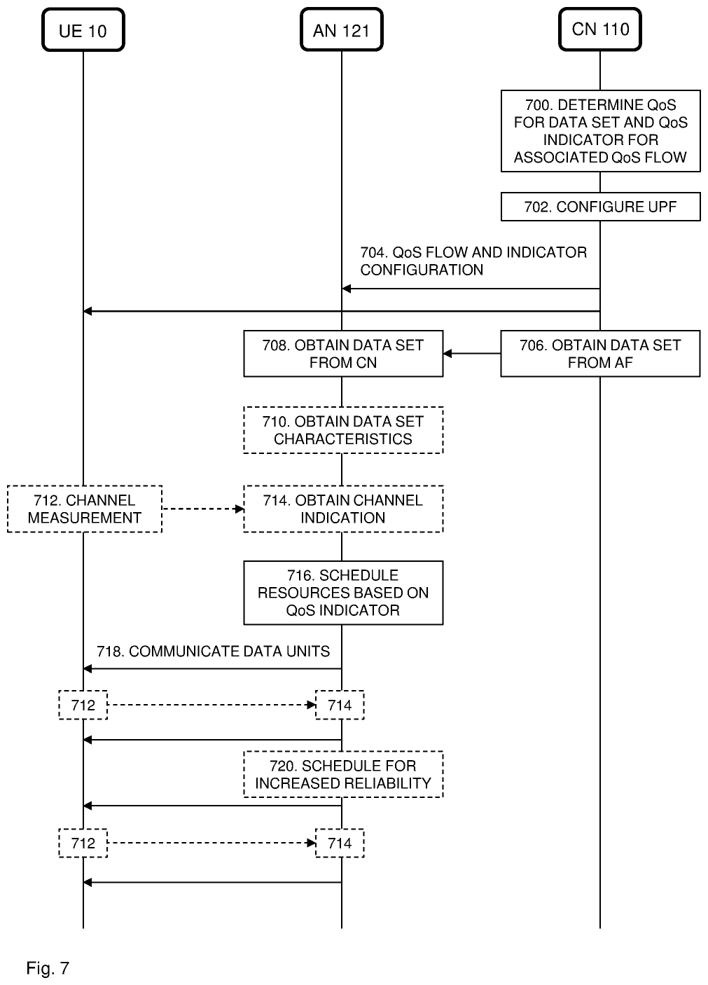

FIG. 7 shows a signaling diagram related to the entities shown and described in FIGS. 1 and 6, and with signaling according to various aspects of the proposed solution. While FIG. 6 illustrates various actions taken by different entities of the CN 110, FIG. 7 provides such actions only for the CN 110 as a whole, for the sake of simplicity.

At 700 a QoS for a data set is determined in the CN 100, and a QoS indicator is determined for an associated QoS Flow for conveying the data set.

At 702 the user plane part of the CN 110 is configured for the QoS Flow. Steps 700 and 702 correspond to step 405 in FIG. 4B.

In the context of a 5G implementation, the UPF 103 is configured with rules etc. so when an IP package arrives to the UPF 103 from the AF 106 the UPF 103 will put the IP-package as a PDU in a GTP-U package. The UPF 103 will add GTP-U headers to the GTP-U package that include the associated QoS meta-data that is valid for that IP-package/PDU.

At 704 the access node 121 and the UE 10 are configured. From the aspect of the access node 121, this corresponds to step 400 of FIG. 4A, and step 415 of FIG. 4B.

At 706 it is indicated that the data of the data set is obtained in the CN 110 from the AF 105.

At 708, the data set is obtained in the access node from the CN 110 in the configured QoS Flow, e.g. under control of the UPF 103.

At 710 the access node obtains data set characteristics, useful in various embodiments. This corresponds to step 410 of FIG. 4A. As noted, this may comprise an indication of total amount of data in the data set, e.g. actual or maximum no of packets, or data size of the data set. This may e.g. be provided by the SMF 102 to the access node 121, or by the UPF in in a GTP-U header (GPRS Tunneling Protocol User Plane), where GPRS stands for General Packet Radio Service. The data set characteristics may thus be received together with the data set in step 708.

At 714 it is indicated that a channel quality indication may be obtained in the access node 121, as discussed. The channel quality indication may be obtained based on UE channel measurements 712. This shall be understood as a schematic illustration. It may thus be noted that obtainment 714 of the channel indication based on UE measurement 712 may alternatively or additionally be carried out in conjunction with the data communication 718, as illustrated further down in the drawing. This corresponds to step 420 of FIG. 4A.

At 716 the access node 121 schedules resources for communication of the data set in the QoS Flow, based on the QoS indicator. Specifically, based on the QoS indicator, the access node 121 is able to increase reliability from first to last data unit, e.g. PDU or TB, related to the data set (e.g. PDU Set). For the embodiment where the QoS indicator identifies an average reliability level, the access node 121 is configured to schedule increased reliability at a last part of the data set in time domain, and a decreased reliability at an initial part of the data set, with respect to the average reliability level. The access node may further be configured to differentiate the reliability levels between e.g. I-frame and P-frame, e.g. where I-frame is more important than P-frame, based on a content indicator identified at 710, e.g. from the PDU headers. The scheduling may also comprise configuring data units of the data set as TBs for communication over the air interface. The scheduling of 716 corresponds to step 430 of FIG. 4A.

At 718 the data communication in DL with the UE 10 is indicated. Here, each arrow is intended to represent one or more data units, whereas the four arrows represent data communication of data units for the same data set.

At 720 the scheduling is changed to obtain an increased reliability level, wherein the subsequent data unit is communicated with a configuration scheduled for a higher reliability than the preceding data unit. The increase in reliability level is made responsive to QoS characteristics identified by the QoS indicator, and may be carried out based on the channel indication 706 and/or the data set characteristics 710.

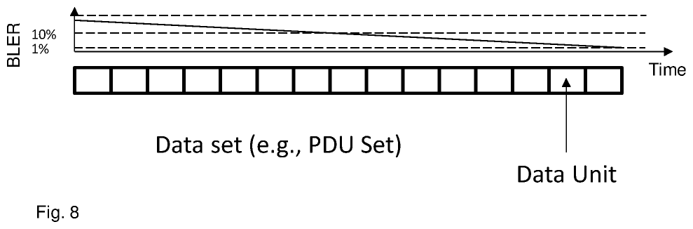

In some embodiments, configuration of different reliability levels may be obtained based on the expected/calculated error rate, e.g. BLER, target in the CSI process, as described. Specifically, the scheduling may be configured for a decreasing BLER during the transmission of the data set. This is schematically illustrated in FIG. 8, where the BLER target is illustrated at the top of the drawing, in either linear or logarithmic scale. Based on the length of the packets the RAN shall then create an offset related to the BLER. In the beginning of the packet the estimated BLER can be relatively high, say 10-15%, then in the end of the PDU set the BLER could be decreased to 1% or even lower in order to have a really quick transmission of these packets and avoid any risk of losing the entire PDU Set and thereby wasting the resources.

In another embodiment, CN 110 provides a new parameter to the access node 121 representing the reliability levels within a PDU set. The plurality of reliability levels are thus indicated by the same QoS indicator. For example, within a PDU set for P-frame transmission there can be 4 levels. The first 25% is level 1, The second 25% is level 2, and so on. The access node 121 uses this information together/jointly with the obtained channel indication 410, 706 to determine the reliability of the transport block transmission configured based on the data set to communicate. In one example, in the first 25%, the reported channel indication (e.g. CQI-Channel Quality Indicator) is associated with 64QAM rate ¾. The access node may apply the transmitted TBS with 64QAM rate ¾. In the second 25%, the reported CQI is still the same. However, as the reliability level has increased to 2, the gNB may apply the transmission with stronger modulation or coding rate, such as 64QAM rate ½. In other words, the channel indication is used for determining coding and modulation to obtain a reliability level defined by the QoS indicator, and wherein a decreasing reliability level is indicated by the QoS indicator in time domain through the data set. By way of example, the QoS indicator may identify the reliability levels as Low, medium, high, or 99%, 99.9%, 99.99%. The access node is then responsible for converting those levels that to relevant BLER target values, for determining the coding and modulation to apply.

In a related example, the access node 121 needs to transmit I-frame (in which I-frame is more important than P-frame). In this case, the first 25% of packages is starting with reliability level 2 (instead of level 1 as in P-frame example above). To arrange for this to be accomplished, the scheduling for an initial part of the data set is configured to target a reliability level which is dependent on a content indicator of the data of the data set. The content indicator may e.g. be provided as PDU header information, and may indicate frame type, such as one of at least I or P. It will be understood that the content indicator and the use thereof to set an initial reliability level may relate to other data characteristics than image frame types.

In various embodiments of the proposed solution, the access node may obtain a pattern on increased reliability level, e.g. from the CN 110, wherein the scheduling is configured dependent on said pattern. The pattern, or scheme, may identify how to increase, either with reference to time or data units. The pattern could be e.g. linear increase, exponential increase, stepwise increase. E.g. the pattern may identify increase linear for each PDU, e.g. by percentage or a factor. By way of example, a subsequent PDU may be scheduled with 4 times higher reliability, the next with 16 times higher reliability etc. Or, if stepwise, e.g. the first 50% of the PDU frames has reliably X, and the rest has reliability X+Y. This can be based on using (1-BLER), the probability that a block is correctly transmitted. Then the reliability could increase from e.g. 90% linearly towards 99% at the end of the data set. According to another example, the increase in reliability may identify non-linear asymptotically growing towards 100% reliability. For example (1-1/n), the reliability may go from 90 to 95% in a first increase, to 97.5% in the next increase, to 98.75% next increase etc., increasing asymptotically towards 100%. In this case the BLER goes as 1/n towards 0.

The features and examples described herein may be combined in any manner that is not clearly contradictory, or as any combination of the items set forth below.

Item 1. A method carried out in an access node of a wireless network for configuring communication of data with a user equipment, UE, the method comprising:
obtaining a quality of service, QoS, indicator associated with a data set comprising inter-dependent data, wherein said obtained QoS indicator identifies an increasing reliability level over the data set in time domain;
scheduling resources for communication of the data set with the UE according to said obtained QoS indicator.

Item 2. The method of item 1, wherein the scheduling according to the QoS indicator comprises configuring resources to obtain an increase in reliability between at least two successive data units of said data set.

Item 3. The method of item 1 or 2, comprising:
obtaining data set character information associated with data set, comprising an indication of a total amount of data in the data set, wherein the QoS indicator identifies the increasing reliability level dependent on said total amount.

Item 4. The method of any preceding item, wherein the QoS indicator identifies the increasing reliability level dependent on a sequence numbering of data units in the data set.

Item 5. The method of any preceding item, wherein the QoS indicator identifies a relative time within the data set for increasing the reliability level.

Item 6. The method of any preceding item, comprising:
receiving an indication to increase the reliability rate after an identified data unit of said data set.

Item 7. The method of any preceding item, comprising:
obtaining a pattern on increased reliability level, wherein the scheduling is configured dependent on said pattern.

Item 8. The method of any preceding item, wherein said QoS indicator identifies an average reliability level for the data set.

Item 9. The method of any preceding item, wherein said QoS indicator identifies a plurality of reliability levels to be targeted within the data set in an order of increasing reliability.

Item 10. The method of any preceding item, comprising:
obtaining an indication of channel quality between the access node and the UE;
wherein the scheduling is based on said indication of channel quality to obtain the increase in reliability level according to the QoS indicator.

Item 11. The method of item 9 or 10, wherein the scheduling for an initial part of the data set is configured to target a reliability level which is dependent on a content indicator of the data of the data set.

Item 12. The method of any preceding item, wherein the scheduling is configured for a decreasing target error rate in time domain in said data set based on said QoS indicator.

Item 13. The method of any preceding item, comprising:
obtaining an indication of priority for respective data units of the data set;
wherein the scheduling provides one of either increased or maintained reliability in time domain between successive data units of the data set, based on said priority.

Item 14. The method of any preceding item, wherein the scheduling comprises configuring modulation and coding scheme and/or radio resources to target the increasing reliability level based on the QoS indicator.

Item 15. The method of any preceding item, wherein said data set is comprised in a Protocol Data Unit, PDU, Set, and wherein the scheduling according to the QoS indicator comprises configuring resources to obtain an increase in reliability between at least two successive transport blocks comprising different PDUs of said PDU set.

Item 16. An access node (121) of a wireless network (100), comprising:
a transceiver (313) for wireless communication with a user equipment; and
logic circuitry (310) configured to control the access node to carry out the method of any preceding item.

Item 17. A method carried out in a core network of a wireless network for configuring an access node to handle communication of a data set comprising inter-dependent data, the method comprising:
determining a quality of service, QoS, for use in a flow for communicating the data set;
configuring the access node with the QoS indicator, identifying the QoS, wherein said QoS identifies an increasing reliability level over the data set in time domain, to be targeted by the access node for communication of the data set.

Item 18. The method of item 17, wherein the QoS indicator identifies the increasing reliability level dependent on a sequence numbering of data units in the data set.

Item 19. The method of item 17 or 18, wherein the QoS indicator identifies a relative time within the data set for increasing the reliability level.

Item 20. The method of any of items 17-19, wherein the QoS indicator identifies the increasing reliability level dependent on a total amount of data in the data set.

Item 21. The method of any of items 17-20, comprising:
providing the access node with an indication to increase the reliability rate at an identified data unit of said data set.

Item 22. The method of any of items 17-21, comprising:
configuring the access node with a pattern for use by the access node to increase reliability level along the data set.

Item 23. The method of any of items 17-22, wherein said QoS indicator identifies a plurality of reliability levels to be targeted by the access node within the data set in an order of increasing reliability.

Item 24. The method of any preceding item, wherein said QoS indicator identifies an average reliability level for the data set.

Item 25. The method of any of items 17-24, wherein the QoS indicator identifies an initial reliability level which is dependent on a content indicator of the data of the data set.

Item 26. The method of any of items 17-25, wherein the QoS indicator identifies a decreasing target error rate in time domain.

Item 27. The method of any of items 17-26, wherein the QoS indicator identifies one of either increased or maintained reliability in time domain between successive data units of the data set, based on a priority indication of the data units.

1. A method carried out in an access node of a wireless network for configuring communication of data with a user equipment (UE), the method comprising:
obtaining a quality of service (QoS), indicator associated with a data set comprising inter-dependent data, wherein said obtained QoS indicator identifies an increasing reliability level over the data set in time domain;
scheduling resources for communication of the data set with the UE according to said obtained QoS indicator.

2. The method of claim 1, wherein the scheduling according to the QoS indicator comprises configuring resources to obtain an increase in reliability between at least two successive data units of said data set.

3. The method of claim 1, comprising:
obtaining data set character information associated with data set, comprising an indication of a total amount of data in the data set, wherein the QoS indicator identifies the increasing reliability level dependent on said total amount.

4. The method of claim 1, wherein the QoS indicator identifies the increasing reliability level dependent on a sequence numbering of data units in the data set.

5. The method of claim 1, wherein the QoS indicator identifies a relative time within the data set for increasing the reliability level.

6. The method of claim 1, comprising:
receiving an indication to increase the reliability rate after an identified data unit of said data set.

7. The method of claim 1, comprising:
obtaining a pattern on increased reliability level, wherein the scheduling is configured dependent on said pattern.

8. The method of claim 1, wherein said QoS indicator identifies an average reliability level for the data set.

9. The method of claim 1, wherein said QoS indicator identifies a plurality of reliability levels to be targeted within the data set in an order of increasing reliability.

10. The method of claim 1, comprising:
obtaining an indication of channel quality between the access node and the UE;
wherein the scheduling is based on said indication of channel quality to obtain the increase in reliability level according to the QoS indicator.

11. The method of claim 9, wherein the scheduling for an initial part of the data set is configured to target a reliability level which is dependent on a content indicator of the data of the data set.

12. The method of claim 1, wherein the scheduling is configured for a decreasing target error rate in time domain in said data set based on said QoS indicator.

13. The method of claim 1, comprising:
obtaining an indication of priority for respective data units of the data set;
wherein the scheduling provides one of either increased or maintained reliability in time domain between successive data units of the data set, based on said priority.

14. The method of claim 1, wherein the scheduling comprises configuring modulation and coding scheme and/or radio resources to target the increasing reliability level based on the QoS indicator.

15. The method of claim 1, wherein said data set is comprised in a Protocol Data Unit (PDU), Set, and wherein the scheduling according to the QoS indicator comprises configuring resources to obtain an increase in reliability between at least two successive transport blocks comprising different PDU s of said PDU set.

16. An access node of a wireless network, comprising:
a transceiver for wireless communication with a user equipment; and
logic circuitry configured to control the access node to carry out the method of claim 1.

17. A method carried out in a core network of a wireless network for configuring an access node to handle communication of a data set comprising inter-dependent data, the method comprising:
determining a quality of service (QoS), for use in a flow for communicating the data set;
configuring the access node with the QoS indicator, identifying the QoS, wherein said QoS identifies an increasing reliability level over the data set in time domain, to be targeted by the access node for communication of the data set.

18. The method of claim 17, wherein the QoS indicator identifies the increasing reliability level dependent on a sequence numbering of data units in the data set.

19. The method of claim 17, wherein the QoS indicator identifies a relative time within the data set for increasing the reliability level.

20. The method of claim 17, wherein the QoS indicator identifies the increasing reliability level dependent on a total amount of data in the data set.

21-27. (canceled)
